(19) United States
(12) Patent Application Publication
(10) Pub. No.: US 2010/0177331 A1
(43) Pub. Date: Jul. 15, 2010

(54) IMAGE FORMING APPARATUS, IMAGE FORMING METHOD AND RECORDING MEDIUM

(75) Inventors: Chikara SUZUKI, Shiojiri-shi (JP); Tomohiro NAKAMURA, Azumino-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/643,139

(22) Filed: Dec. 21, 2009

(30) Foreign Application Priority Data
Jan. 14, 2009 (JP) 2009-005896

(51) Int. Cl. H04N 1/60; G06K 9/46

(52) U.S. Cl. 358/1.9; 382/165

(57) ABSTRACT

An image forming apparatus, which performs image formation by using various colorants, includes a bitmap data generation unit that generates bitmap data, in which each pixel has a gradation value of each color of the colorants, with respect to image formation objects, a label generation unit that generates label information of a relevant pixel for each pixel based on the bitmap data or label information of peripheral pixels of the relevant pixel, and a correction unit that corrects the bitmap data based on the label information. The image formation is performed based on the corrected bitmap data, and the label information includes information on a color of a pixel adjacent to a region to be corrected when the pixel exists in the region to be corrected, and includes information for identifying a color of the relevant pixel when the pixel does not exist in the region to be corrected.

### BACKGROUND

1. Technical Field

The present invention relates to an image forming apparatus or the like that performs a process of supplying colorants for each color, and more particularly to an image forming apparatus or the like that can reliably and efficiently perform a correction process with respect to the so-called misregistration occurring due to the process of supplying colorants.

2. Related Art

According to an image forming apparatus such as a laser printer, a process of attaching colorants of each color to a sheet, an intermediate medium or a photosensitive body by supplying the colorants thereto is performed independent of each color. Thus, a case may occur in which formed images of each color are relatively out of alignment depending on the mechanical accuracy of the apparatus. If such misregistration (also called color shift) occurs, it adversely affects the output quality, for example, producing white portions (voids) that have not been initially present on the boundaries between characters and background. In this regard, a process of correcting in advance image data to be output has been performed to prevent a defect caused by such misregistration.

Japanese Patent No. 3852234 suggests an apparatus in the related technical field that effectively prevents the so-called edge light coloring and performs a rapid process. Further, JP-A-2002-165104 discloses an apparatus that performs a trapping process such that an object seems to be of the same order as an actual one even if the printing deviation occurs.

However, in the apparatus disclosed in Japanese Patent No. 3852234, since a region where image data is corrected is determined in object units of an image, when objects such as characters or graphics, which have to be corrected originally, are incorporated into objects such as images, which are not corrected, in an application level of supplying image data, correction is not performed with respect to these objects, so that a correction process is not reliably performed. Further, image data received in an image forming apparatus such as a printer is represented by a PDL of various formats, and the classification of objects is established for each format. Therefore, in the aforementioned process in object units, respective processing procedures have to be prepared for each format and the process becomes complicated and inefficient.

Further, in the apparatus disclosed in JP-A-2002-165104, a process of establishing a correction range and a correction color by the brightness difference between adjacent regions may become complicated.

On the other hand, in the most general usage mode of image forming apparatuses, a void caused by the misregistration that occurs between the black character or graphic and a color background becomes a serious problem. However, no method for resolving such a problem has been suggested.

In this regard, a method for efficiently resolving such a problem is needed in a process in pixel units that is considered to be a time-consuming process.

### SUMMARY

An advantage of some aspects of the invention is to provide an image forming apparatus or the like that can reliably and efficiently perform a correction process with respect to the so-called misregistration occurring due to a process of supplying colorants for each color.

According to one aspect of the invention, there is provided an image forming apparatus for performing image formation by using various colorants, the image processing apparatus including: a bitmap data generation unit that generates bitmap data, in which each pixel has a gradation value of each color of the colorants, with respect to image formation objects; a label generation unit that generates label information of a relevant pixel for each pixel based on the bitmap data or label information of peripheral pixels of the relevant pixel; and a correction unit that corrects the bitmap data based on the label information, wherein the image formation is performed based on the corrected bitmap data, and the label information includes information on a color of a pixel adjacent to a region to be corrected when the pixel exists in the region to be corrected, and includes information for identifying a color of the relevant pixel when the pixel does not exist in the region to be corrected.

Further, in this case, it is preferable that the label information of the pixel existing in the region to be corrected includes distance, information from the adjacent pixel.

Further, in this case, it is preferable that the region to be corrected is a region where the gradation value of a black color of the bitmap data is equal to or larger than a predetermined value while the gradation value of other colors is 0, and does not include a section in which the gradation value of the black color varies.

Further, in this case, it is preferable that, among the image formation objects, in a region which is in contact with a pixel in which the gradation value of all colors of the bitmap data is 0, and in which the gradation value of a black color of the bitmap data is equal to or larger than a predetermined value while the gradation value of other colors is 0, label information of a pixel in a predetermined range from the pixel being in contact with the region includes distance information from the pixel being in contact with the region.

Further, in this case, it is preferable that, when the gradation value of the bitmap data of the region to be corrected is a highest value for a black color and is 0 for remaining colors, the correction unit performs the correction by increasing a gradation value of a relevant bitmap data with respect to the color of the adjacent pixel by a predetermined amount, and, when the gradation value of the bitmap data of the region to be corrected is not the highest value in the case of the black color and is 0 in the case of the remaining colors, the correction unit performs the correction by changing the gradation value of the bitmap data into values of each color of a case where a monochromatic black color having the gradation value of the black is represented by a mixed black color including colors other than the black color.

According to another aspect of the invention, there is provided an image forming method in an image forming apparatus for performing image formation by using various colorants, the image processing method including: generating bitmap data, in which each pixel has a gradation value of each color of the colorants, with respect to image formation objects; generating label information of a relevant pixel for each pixel based on the bitmap data or label information of peripheral pixels of the relevant pixel; and correcting the bitmap data based on the label information, wherein the image formation is performed based on the corrected bitmap data, and the label information includes information on a color of a pixel adjacent to a region to be corrected when the pixel exists in the region to be corrected, and includes information for identifying a color of the relevant pixel when the pixel does not exist in the region to be corrected.

According to further another aspect of the invention, there is provided a print data generation program that causes a host device of an image forming apparatus to execute a process of generating print data for the image forming apparatus that performs image formation by using various colorants, the print data generation program causing the host device to execute: generating bitmap data, in which each pixel has a gradation value of each color of the colorants, with respect to image formation objects; generating label information of a relevant pixel for each pixel based on the bitmap data or label information of peripheral pixels of the relevant pixel; and correcting the bitmap data based on the label information, wherein the image formation is performed based on the print data including the corrected bitmap data, and the label information includes information on a color of a pixel adjacent to a region to be corrected when the pixel exists in the region to be corrected, and includes information for identifying a color of the relevant pixel when the pixel does not exist in the region to be corrected.

Other objects and features of the invention will become apparent from the below-described embodiment of the invention.

### BRIEF DESCRIPTION OF THE DRAWINGS

The invention will be described with reference to the accompanying drawings, wherein like numbers reference like elements.

FIG. 1 is a view illustrating the configuration of an image forming apparatus embodied as a printer according to an embodiment of the invention.

FIG. 2 is a view illustrating labels assigned to each pixel.

FIG. 3 is a flowchart illustrating the entire procedure of a correction process as a measure against misregistration.

FIGS. 4A and 4B is an exemplary view illustrating bitmap data and a label plane.

FIGS. 5A to 5C are views illustrating the direction in which second labeling is performed.

FIGS. 6A and 6B are views illustrating the process content in second labeling.

FIGS. 7A and 7B are views illustrating the necessity of a reciprocation process in second labeling.

FIG. 8 is a flowchart illustrating the procedure of a second labeling process.

FIG. 9 is a flowchart illustrating the procedure of a backward process in second labeling.

FIG. 10 is a flowchart illustrating the procedure of a third labeling process according to a first method.

FIGS. 11A to 11C are views illustrating transfer of information related to W.

FIG. 12 is a flowchart illustrating the procedure of a third labeling process according to a second method.

FIG. 13 is a flowchart illustrating the procedure of a third labeling process according to a third method.

FIG. 14 is a flowchart illustrating the procedure of a third labeling process according to a fourth method.

FIGS. 15A to 15C are views illustrating transfer of information related to W.

FIGS. 16A to 16D are views illustrating the content of a correction process.

FIGS. 17A to 17D are views illustrating the content of a correction process.

### DESCRIPTION OF EXEMPLARY EMBODIMENTS

Hereinafter, an embodiment of the invention will be described with reference to the accompanying drawings. However, the technical scope of the invention is not limited to the embodiment. Further, the same reference numerals or reference symbols are used to designate the same or similar elements throughout the drawings.

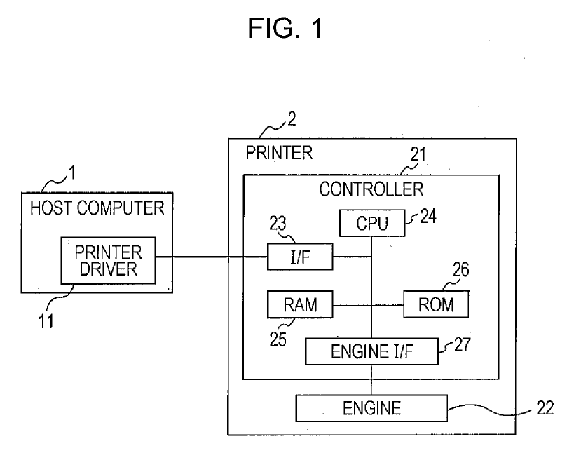

FIG. 1 is a view illustrating the configuration of an image forming apparatus embodied as a printer according to the embodiment of the invention. The printer 2 as illustrated in FIG. 1 is a printer to which the invention is applied, performs labeling with respect to each pixel in bitmap data of an image to be printed, and performs a correction process with respect to misregistration based on label information assigned to each pixel. Further, the label information assigned to each pixel is determined from label information assigned to other pixels adjacent to the pixel. When a pixel is one to be corrected, the label information includes color information of pixels to which a region to be corrected including the pixel is adjacent. Thus, the printer 2 reliably and efficiently performs the process against the misregistration.

A host computer 1 as illustrated in FIG. 1 serves as a host device that transmits a print request to the printer 2, and includes a personal computer or the like. The host computer 1 includes a printer driver 11. When the print request is made, the printer driver 11 generates print data including image data and a control command and transmits the print data to the printer 2 in response to user manipulation. Herein, the data transmitted from the printer driver 11 to the printer 2 is represented by PDL. Further, the printer driver 11 can be composed of a program designed to execute the above process and a control device (not illustrated) of the host computer 1 that executes the process according to the program. In addition, the program dedicated for the printer driver 11 can be installed in the host computer 1 through downloading from a predetermined site via a network such as the Internet, or can be installed in the host computer 1 from a storage medium such as a CD.

The printer 2 is the so-called laser printer including a controller 21, an engine 22 or the like as illustrated in FIG. 1.

The controller 21 performs a process of outputting a printing instruction to the engine 22 after receiving the print request from the host computer 1, and includes an I/F 23, a CPU 24, a RAM 25, a ROM 26 and an engine I/F 27 as illustrated in FIG. 1.

The I/F 23 is a unit that receives the print data transmitted from the host computer 1.

The CPU 24 is a unit that controls various processes performed by the controller 21. When the print request is received from the host computer 1, the CPU 24 performs a process of generating bitmap data (plane data of each color) which is obtained by executing a predetermined image process with respect to the image data included in the received print data and then is output to the engine 22, a process of instructing an accurate printing process to the engine 22 after interpreting the control command included in the print data, or the like. Further, the CPU 24 performs a correction process as a measure against the misregistration in relation to the process of generating the bitmap data. The embodiment is characterized in that the correction process is performed in the printer 2, and detailed description thereof will be given later. The processes executed by the CPU 24 are performed mainly according to the program stored in the ROM 26.

The RAM 25 is a memory that stores the received print data, the image data after each process is performed, or the like, and stores the above-described bitmap data (plane data) of each color and label data (plane data) generated with respect to the bitmap data. The bitmap data and the label data will be descried in detail later.

The ROM 26 is a memory that stores a program of each process executed by the CPU 24.

The engine I/F 27 is a unit that serves as an interface between the controller 21 and the engine 22. In detail, when printing is performed by the engine 22, the engine I/F 27 reads the image data (the bitmap data after the correction process), which is stored in the RAM 25, at a predetermined timing, and transfers the image data to the engine 22 after performing a predetermined process with respect, to the image data. Although not illustrated in FIG. 1, the engine I/F 27 includes a memory for temporarily storing data, a decompression unit, a screen process unit or the like, and performs the decompression of compressed data and a screen process of converting the compressed data into dot data with respect to the image data read out from the RAM 25. In detail, the engine I/F 27 is provided by ASIC.

Although not illustrated in FIG. 1, the engine 22 includes a mechanism controller and a printing mechanism. Although not illustrated in FIG. 1, the printing mechanism includes a photosensitive drum, a charging unit, an exposure unit, a development device, a transfer unit or the like. When the printing is performed, the photosensitive drum is electrically charged by the charging unit, and the charged photosensitive drum is irradiated with a beam of a light source such as a laser or LED array included in the exposure unit, so that an electrostatic latent image is formed. Thereafter, the latent image is developed into an image by a developer of the development device provided with a toner cartridge that receives the developer (toner), and the developed toner image is transferred by the transfer unit onto a print medium such as a sheet, where the image is fixed by a fixing unit. Then, the print medium is discharged out of the printer 2. In the printer 2, colorants of CMYK colors are used as the developer, and the supply of the colorants is performed independently for each color in at least one of the processes of supplying the colorants to the photosensitive body, supplying the colorants to an intermediate transfer medium, and supplying the colorants to the print medium. Thus, in the printer 2, the image position on the print medium may be shifted depending on colors.

In the printer 2 having the configuration as described above, the print request is received from the host computer 1, the print data is interpreted and the bitmap data having gradation values of each color for each pixel is generated from the image data in the PDL format. The bitmap data is composed of plane data of each CMYK color of the colorants with respect to one sheet of print medium, and is stored in an image buffer of the RAM 25. Then, the correction process as the measure against the misregistration is performed with respect to the bitmap data, the corrected bitmap data is read out from the engine I/F 27, and the printing process is performed by the engine 22 after the above-described process. As descried above, the embodiment is characterized in that the correction process as the measure against the misregistration is performed in the printer 2. Hereinafter, the correction process will be described in detail.

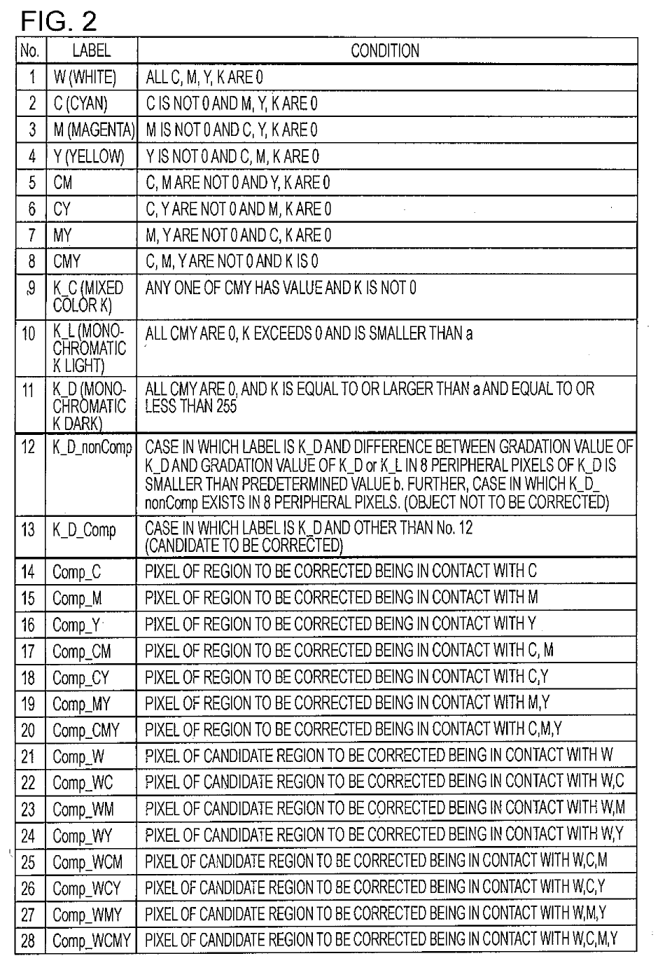

According to the correction process in the printer 2, since the labeling, that is, the assignment of the label data is performed with respect to each pixel of the bitmap data, the label data is first described. FIG. 2 is a view illustrating labels assigned to each pixel. As illustrated in FIG. 2, 28 labels No. 1 to 28 are prepared.

Among the 28 labels No. 1 to 28, labels No. 1 to 11 are assigned in a first labeling which will be described later. These labels are used as information of identifying colors of the pixels. Since each pixel has gradation values (e.g., values of 0 to 255) of CMYK colors at the time point at which the correction is performed, these values are set such that labels satisfying the conditions as illustrated in the “conditions” of FIG. 2 are, assigned. For example, the label W (white) is assigned to a pixel in which all gradation values of CMYK colors are 0, and the label K_D (monochromatic K dark) is assigned to a pixel in which all gradation values of CMY are 0 and the gradation value of K is equal to or higher than a (e.g., 166) and is equal to or less than 255. Other labels are properly assigned to corresponding pixels according to the conditions as illustrated in FIG. 2.

In colors satisfying the conditions related to the labels No. 2 to 8, since the gradation value of K is 0, K toner is not used. However, since other colors may be provided, all these colors will be generically referred to as “Color”.

Further, colors satisfying the conditions related to the labels No. 1, 9, 10 and 11 will be referred to as “White”, “Mixed Color K”, “Monochromatic K Light” and “Monochromatic K Dark”, respectively. In the printer 2, since the above-described void may occur in a section in which a region of the “Monochromatic K Dark” is in contact with the “Color”, correction is performed with respect to the region of the “Monochromatic K Dark” to prevent the void.

Further, No. 12 and 13 represent labels assigned in a second labeling which will be described later. The labels are used to classify pixels having the label No. 11 assigned thereto into an object not to be corrected, and a candidate to be corrected. The label K_D_nonComp of the object not to be corrected is assigned to a pixel having a color of the “Monochromatic K Dark”, which may be corrected, that is, a pixel having the label K_D assigned thereto. In detail, the label K_D_nonComp is assigned to an object, in which density of K varies little by little in the region (region having only the color of K) of the monochromatic K which includes the corresponding pixels. In other words, the label K_D_nonComp is assigned to a pixel of the so-called gradation region. Meanwhile, the label K_D_Comp of the candidate to be corrected is assigned to a pixel, which does not satisfy the condition of the label K_D_nonComp, among pixels having the label K_D assigned thereto. The pixel, to which the label K_D_Comp is assigned, becomes a candidate for which the correction for preventing the misregistration is performed.

Next, No. 14 to 28 represent labels assigned in a third labeling which will be described later. These labels represent color information of pixels of the “Color” or the “White”, which is in contact with the region (exactly, a region where the pixels having the label K_D_Comp assigned thereto are arranged in a row) of the “Monochromatic K Dark” including the corresponding pixels. Then, the labels No. 14 to 20 are assigned to pixels to be finally corrected, and the labels No. 21 to 28 are assigned to pixels separated from an object to be corrected, which is a short distance away from the pixel of the “White”.

For example, the Comp_C of No. 14 is assigned to a pixel in the region to be corrected, which is adjacent to the pixel to which the label C of No. 2 is assigned. Further, the Comp_WC of No. 22 is assigned to a pixel which is just a short distance (e.g., within the range of five pixels) away from the pixel, to which the W is assigned, among pixels included in a candidate region (a region where the pixels having the label K_D_Comp assigned thereto are arranged in a row) to be corrected, which is adjacent to both the pixel to which the label C of No. 2 is assigned and the pixel to which the label W of No. 1 is assigned. The same manner is applied to other labels.

A case may occur in which the labels No. 14 to 28 include predetermined distance information by several labeling methods which will be described later, in addition to the labels as illustrated in FIG. 2.

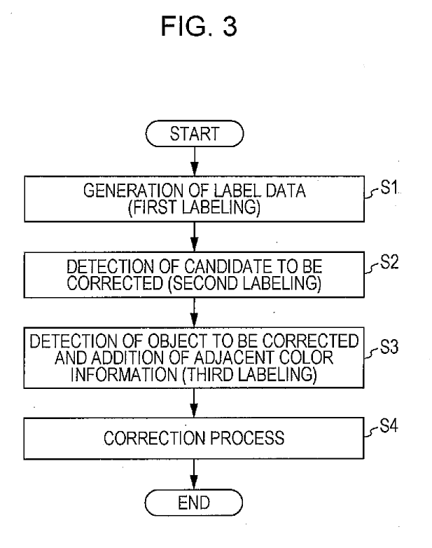

The correction process as the measure against the misregistration is performed using the label information as described above. FIG. 3 is a flowchart illustrating the entire procedure of the correction process. As described above, after the print request is received, if the generation of the bitmap data is completed by the CPU 24, the correction process is started, and generation of a label plane (first labeling) is first performed (Step S1). In detail, the pixels are classified into predetermined groups based on the generated bitmap data, and labels corresponding to the classified group are assigned to each pixel. That is, the labels of No. 1 to 11 as illustrated in FIG. 2 are assigned corresponding to colors (gradation values of the bitmap data) of the pixels. The information of the assigned labels is maintained in the RAM 25 as label data, and label planes are generated with respect to one sheet of the print medium, similarly to the bitmap data of each color.

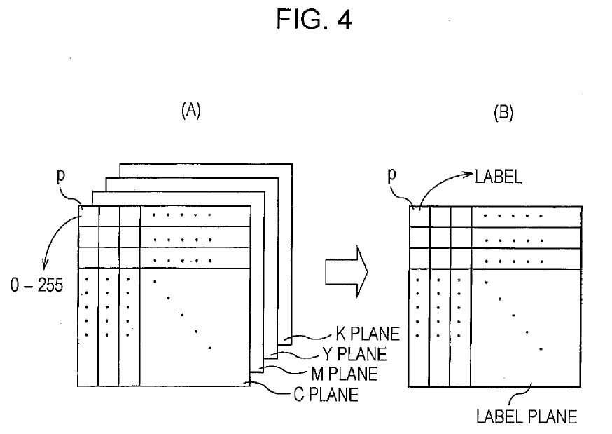

FIG. 4 is an exemplary view illustrating the bitmap data and the label plane. The generated bitmap data is illustrated in (A) of FIG. 4. As described above, the bitmap data includes a C plane, an M plane, a Y plane and a K plane. Each pixel (p in the FIG. 4) of each plane has a gradation value of each color. Herein, each color is represented by 256 gradations from 0 to 255, and each pixel has any one of the values from 0 to 255.

The label data generated from the bitmap data as illustrated in (A) of FIG. 4 is illustrated in (B) of FIG. 4. Each pixel (p in the FIG. 4) has the label (data). Further, the generated label plane has identification information of colors of the pixels in the first labeling level, but the content of the label plane is properly updated to necessary information in the second labeling and the third labeling which will be described later.

Then, the procedure goes to the second labeling so that detection of the candidate to be corrected is performed (Step S2). In the relevant process, a candidate pixel, for which the correction process as the measure against the misregistration is performed; is detected from object pixels. In detail, it is determined whether the pixel, to which the label K_D is assigned in the first labeling, is the object not to be corrected or the candidate to be corrected with reference to the label information of peripheral pixels, and the label of the pixel is updated to the K_D_nonComp or the K_D_Comp in response to a result of the determination. That is, data of the label plane is rewritten.

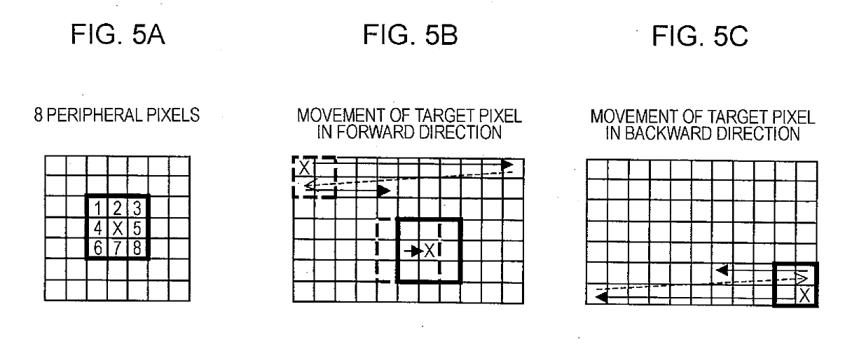

Further, the relevant process is sequentially performed with respect to left upper pixels of the target image one by one in the forward direction and the backward direction. FIGS. 5A to 5C are views illustrating the direction in which the relevant process is performed. FIG. 5A illustrates eight peripheral pixels (1 to 8) which are, used to determine a pixel to be processed, that is, a target pixel X and the label thereof.

In the second labeling, after the left upper pixel of the target image is selected as the target pixel X, the process is performed using the peripheral pixels of the target pixel X. Next, the target pixel X is moved by one pixel, the process is performed in the direction indicated by an arrow in FIG. 5B, and right lower pixels of the target image are processed, so that the forward process is ended. Then, after the right lower pixel of the target image is selected as the target pixel X and the process is started again, the target pixel X is moved by one pixel, the process is performed in the direction indicated by an arrow in FIG. 5C, and the left upper pixels of the target image are processed, so that the backward process is ended. The second labeling process is performed through one-time reciprocation.

Further, in the process for each pixel, in the case in which the target pixel X is a pixel having the label K_D assigned thereto, when a pixel, which has the label K_D or K_L and the gradation value of K smaller than b (e.g., 5) with respect to the gradation value of K of the target pixel X, or a pixel, which has the label K_D_nonComp previously assigned thereto, exists in the peripheral pixels (the above-described eight peripheral pixels) of the target pixel X, the label of the target pixel X is updated to the K_D_nonComp, and the target pixel X is set as an object not to be corrected.

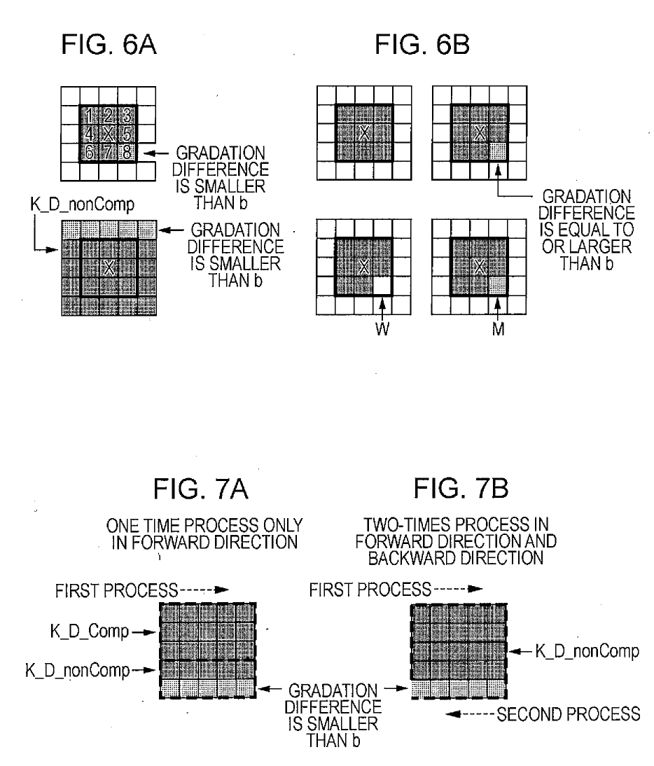

FIGS. 6A and 6B are views illustrating the relevant process. FIG. 6A is an exemplary view illustrating a case in which the label of the target pixel X is the K_D_nonComp, and FIG. 6B is an exemplary view illustrating a case in which the label of the target pixel X is the K_D_Comp. In FIGS. 6A and 6B, a pixel of a dark gray identical to that of the target pixel X is a pixel of the label K_D, which has the gradation value of K identical to that of the target pixel X.

Referring to the target pixel X located at the upper portion as illustrated in FIG. 6A, the peripheral pixel (8) has the label K_D or K_L and the gradation value of K smaller than b (e.g., 5) with respect to the gradation value of K of the target pixel X. In the case of the target pixel X located at the lower portion, since each pixel in the first row has the label K_D or K_L and the gradation value of K smaller than b (e.g., 5) with respect to the gradation value of K of the target pixel X, and each pixel in the second row has the label K_D_nonComp by the above-described forward process, a pixel having the label K_D_nonComp exists in the peripheral pixels, so that the label of the target pixel X is the K_D_nonComp.

FIG. 6B illustrates a case in which all peripheral pixels have the label K_D and the gradation value of K identical to that of the target pixel X in the sequence of the left upper, the right upper, the left lower and the right lower, a case in which the peripheral pixel located at the right lower portion has the label K_D or K_L and the gradation value of K equal to or higher than b with respect to the gradation value of K of the target pixel X, a case in which the peripheral pixel located at the right lower portion has the label W, and a case in which the peripheral pixel located at the right lower portion has the label M. Since all cases do not satisfy the condition of the above-described object not to be corrected, the label of the target pixel X is updated to the K_D_Comp.

FIGS. 7A and 7B are views illustrating the necessity of the above-described reciprocation process. Referring to the example as illustrated in FIGS. 7A and 7B, in the target range of a (5×5) pixel, all pixels in the four rows located at the upper portion have the same gradation value of K and the label K_D, and all pixels in the lowest row have the label K_D and the gradation value of K smaller than b (e.g., 5) with respect to the gradation value of K of the above upper pixels.

FIG. 7A illustrates a state of a label at the time point at which the forward process is ended. In relation to pixels in the upper 3 rows, since a pixel determined as an object not to be, corrected appears in peripheral pixels through the above-described process, the label K_D_Comp is assigned. However, since the target range of the (5×5) pixel corresponds to a region where the density of K varies little by little in the region (region having only the color of K) of monochromatic K, the labels of pixels included in the range should be the K_D_nonComp as described above. Thus, it can be understood that a preferable result cannot be obtained by only the forward process.

FIG. 7B illustrates a state of a label at the time point at which the reciprocation process in the forward direction and the backward direction is ended. The labels of all pixels included in the target range of the (5×5) pixel are the K_D_nonComp, so that a preferable result is obtained. In the second process in the backward direction, even if any pixel is processed, the K_D_nonComp appears in the peripheral pixels thereof, so that the label K_D_nonComp is assigned to all pixels.

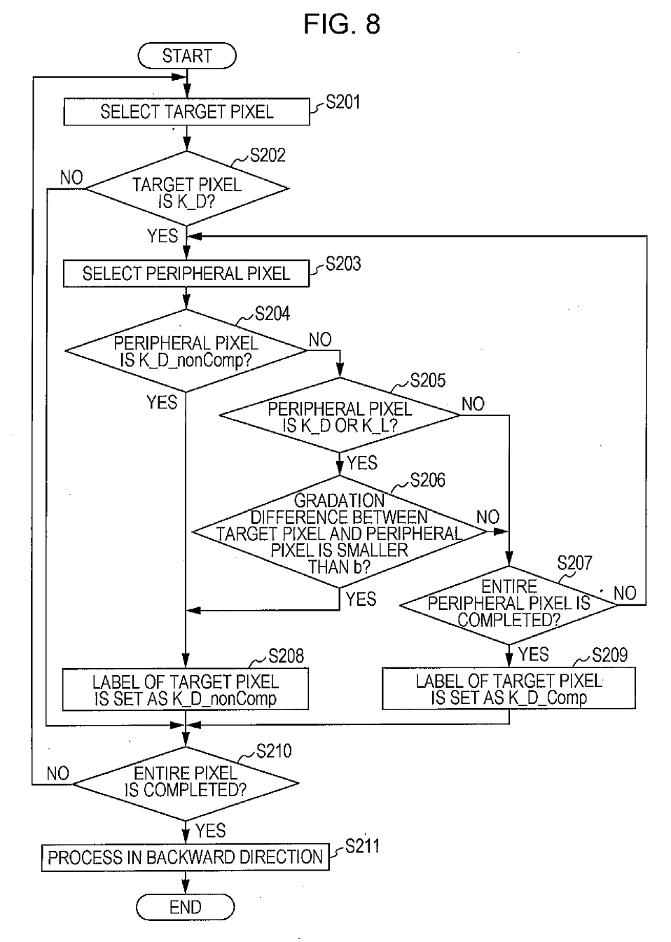

FIG. 8 is a flowchart illustrating a detailed procedure of the second labeling process. As described above, the left upper pixel of the target image is first selected as the target pixel (Step S201), and it is checked whether the label of the target pixel at that time is the K_D with reference to the label plane (Step S202). As a result of the checking, when the label of the target pixel is not the K_D (No in Step S202), the process for the target pixel is ended. Then, the process for the next pixel in the forward direction goes to Step S201 in the case of “No” in Step S210.

Meanwhile, when the label of the target pixel is the K_D (Yes in Step S202), one peripheral pixel is selected (Step S203), and it is checked whether the label of the peripheral pixel at that time is the K_D_nonComp with reference to the label plane (Step S204). As a result of the checking, when the label of the peripheral pixel is the K_D_nonComp (Yes in Step S204), the label of the target pixel is updated to the K_D_nonComp (Step S208), the process for the target pixel is ended. Then, the process for the next pixel in the forward direction goes to Step S201 in the case of “No” in Step S210.

Meanwhile, when the label of the peripheral pixel is not the K_D_nonComp (No in Step S204), it is checked whether the label of the peripheral pixel is the K_D or K_L (Step S205). When the label of the peripheral pixel is the K_D or K_L (Yes in Step S205), it is checked whether the difference between the gradation value of the peripheral pixel and the gradation value of the target pixel is smaller than b with reference to the K plane (Step S206). If the condition is satisfied (Yes in Step S206), the label of the target pixel is updated to the K_D_nonComp (Step S208), the process for the target pixel is ended. Then, the process for the next pixel in the forward direction goes to Step S201 in the case of “No” in Step S210.

Meanwhile, when the label of the peripheral pixel is not the K_D or K_L (No in Step S205) and the condition of Step S206 is not satisfied (No in Step S206), the process for the next peripheral pixel is performed in the forward direction (No in Step S207, S203). Further, after the same process is repeated from Step S203, when the process for all peripheral pixels (eight in the above description) is ended without performing Step S208 (Yes in Step S207), the label of the target pixel is updated to the K_D_Comp (Step S209), the process for the target pixel is ended. Then, the process for the next pixel in the forward direction goes to Step S201 in the case of “No” in Step 5210.

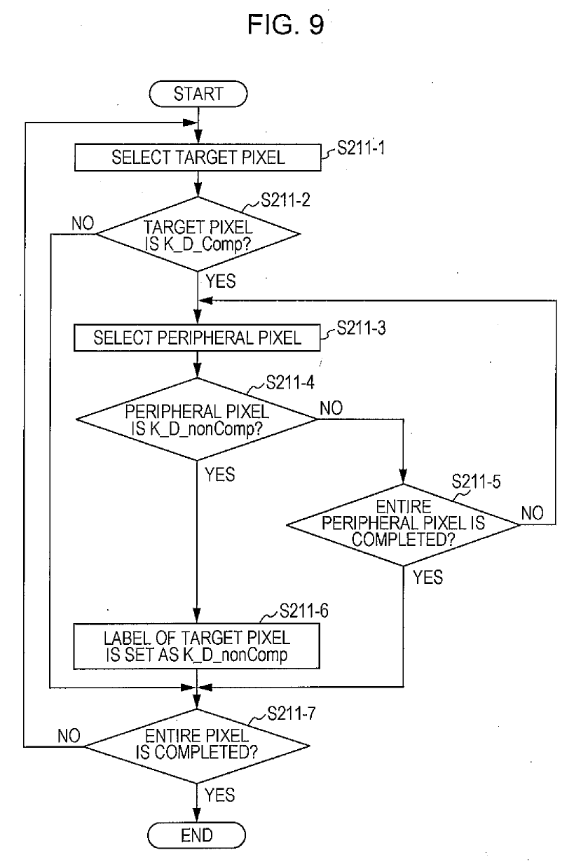

In this manner, if the process for all pixels in the forward direction is ended (Yes in Step S210), the above-described backward process is performed (Step S211). FIG. 9 is a flowchart illustrating the procedure of the backward process.

First, the right lower pixel of the target image is selected as the target pixel (Step S211-1), and it is checked whether the label of the target pixel at that time is the K_D_Comp with reference to the label plane (Step S211-2). As a result of the checking, when the label of the target pixel is not the K_D_Comp (No in Step S211-2), the process for the target pixel is ended. Then, the process for the next pixel in the backward direction goes to Step S211-1 in the case of “No” in Step S211-7.

Meanwhile, when the label of the target pixel is the K_D_Comp (Yes in Step S211-2), one peripheral pixel is selected (Step S211-3), and it is checked whether the label of the peripheral pixel at that time is the K_D_nonComp with reference to the label plane (Step S211-4). As a result of the checking, when the label of the peripheral pixel is the K_D_nonComp (Yes in Step S211-4), the label of the target pixel is updated to the K_D_nonComp (Step S211-6), the process for the target pixel is ended. Then, the process for the next pixel in the backward direction goes to Step S211-1 in the case of “No” in Step S211-7.

Meanwhile, when the label of the peripheral pixel is not the K_D_nonComp (No in Step S211-4), the process for the next peripheral pixel is performed (No in Step S211-5, S211-3). Further, after the same process is repeated from Step S211-3, when the process for all peripheral pixels is ended without performing Step S211-6 (Yes in Step S211-5), the process for the target pixel is ended. Then, the process for the next pixel in the backward direction goes to Step S211-1 in the case of “No” in Step S211-7.

In this manner, if the process for all pixels in the backward direction is ended (Yes in Step S211-7), the backward process is ended, so that the second labeling process (S2) is ended.

As described above, the second labeling process is performed, so that the label of the pixel having the label K_D through the first labeling is updated to the K_D_nonComp or K_D_Comp, and thus the pixel having the updated label K_D_Comp becomes a candidate to be corrected. In other words, the second labeling process is performed, so that the region, where variation of density such as gradation occurs, is excluded from the region of the “Monochromatic K Dark”, which is an object to be corrected for preventing the above-described void.

Thereafter, the third labeling process is performed (Step S3 of FIG. 3). In the third labeling process, the final detection of an object to be corrected and the assignment of information on an adjacent color are performed using the label plane information. Similarly to the second labeling, according to the third labeling, the process for the target pixel is performed using the label information of the eight peripheral pixels, and the target pixel is moved for each pixel and the process is performed. Further, in the third labeling process, a reciprocation process in the forward direction and the backward direction is performed. In detail, four process methods are provided and any one of the first to fourth methods which will be described below can be used.

First, according to the first method, when a target pixel has labels W, C, M and Y, color information thereof is transferred to the peripheral pixels of a candidate to be corrected, so that the labels of the peripheral pixels are updated. Further, the transfer of the information of W is limited to the range of a predetermined distance (e.g., five pixels) from the pixel having the label “W”. As described above, the pixel having the label W is excluded from an object to be corrected. Thus, the transfer of the information of W is limited, so that only the predetermined range adjacent to the region of “White” can be prevented from being corrected.

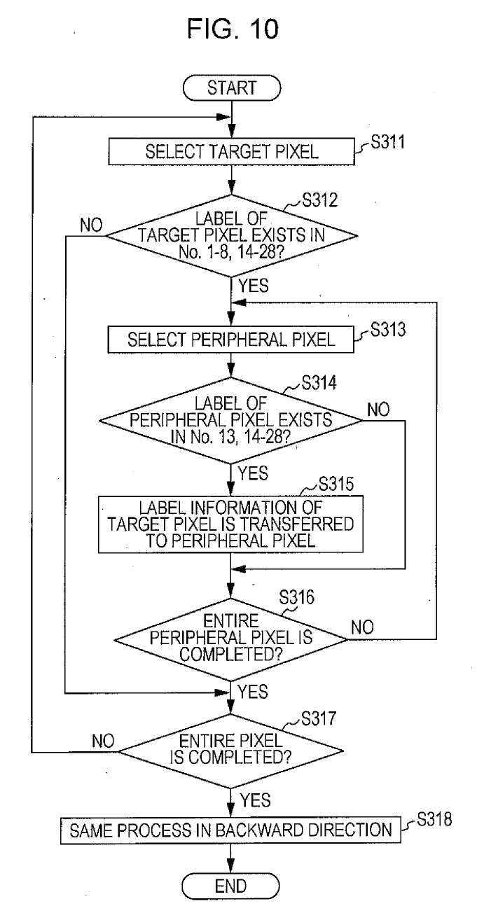

FIG. 10 is a flowchart illustrating the procedure of the third labeling process according to the first method. According to the first method, first, the left upper pixel of a target image is selected as a target pixel (Step S311), and it is checked whether the label of the target pixel at that time exists in No. 1 to 8 and 14 to 28 as illustrated in FIG. 2 with reference to the label plane (Step S312). That is, it is checked whether the label of the target pixel corresponds to W, C, M or Y as color information. As a result of the checking, when the label of the target pixel does not exist in No. 1 to 8 and 14 to 28 (No in Step S312), the process for the target pixel is ended. Then, the process for the next pixel is performed in the forward direction (No in Step S317, S311).

Meanwhile, when the label of the target pixel exists in No. 1 to 8 and 14 to 28 (Yes in Step S312), one peripheral pixel is selected (Step S313), and it is checked whether the label of the peripheral pixel at that time exists in No. 13 and 14 to 28 as illustrated in FIG. 2 with reference to the label plane (Step S314). That is, it is checked whether the peripheral pixel is a candidate to be corrected. As a result of the checking, when the label of the peripheral pixel exists in No. 13 and 14 to 28 (Yes in Step S314), the label information of the target pixel is transferred to the peripheral pixel (Step S315).

For example, when the label of a target pixel is the C and the label of a peripheral pixel is the K_D_Comp, the color information of the C is transferred, so that the label of the peripheral pixel is updated to the Comp_C. Further, when the label of a peripheral pixel is the Comp_M, the label of the peripheral pixel is updated to the Comp_CM. In addition, when the label of a target pixel is the Comp_Y and the label of a peripheral pixel is the Comp_M, the color information of the Y is transferred, so that the label of the peripheral pixel is updated to the Comp_MY. Similarly to this, even in other cases, information of a color, which is not provided to a peripheral pixel, is transferred to the peripheral pixel, so that the label of the peripheral pixel is changed to a label including the color.

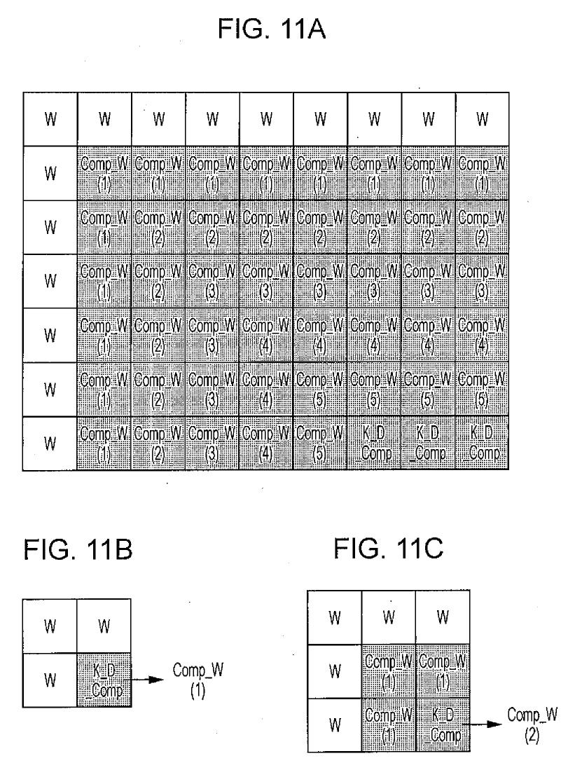

When the transferred color is W, the color information of the W is transferred only to pixels existing in the range of five pixels from the pixel having the label “W” as described above. Herein, in order to allow the range (distance) to be understood, distance information from the pixel having the label “W” is also transferred thereto. FIGS. 11A to 11C are views illustrating the transfer related to the W.

FIGS. 11A to 11C illustrate an example in which the region (gray section) of the “Monochromatic K Dark” is in contact with the region (white section) of the “White”. As illustrated in FIG. 11A, pixels (having small rectangular shapes) existing in the region of the “White” has the label W. Further, among pixels (having small rectangular shapes) existing in the region of the “Monochromatic K Dark”, pixels existing within the range of five pixels from the region of the “White” have the label Comp_W together with information on the shortest distance from the region of the “White”. Since the information of the W is not transferred to pixels which do not exist in the range of the five pixels from the region of the “White”, the pixels have the label K_D_Comp.

FIG. 11B illustrates the four left upper pixels in FIG. 11A. Herein, when a target pixel is the left upper pixel, the label of a right lower peripheral pixel is updated from the K_D_Comp to Comp_W (1). In this way, when the label of a target pixel is “W”, the distance information of a peripheral pixel which is a candidate to be corrected is set as (1).

FIG. 11C illustrates the nine left upper pixels in FIG. 11A. Herein, when a target pixel is the center pixel, the label of a right lower peripheral pixel is updated from the K_D_Comp to Comp_W (2). In this way, when the label of a target pixel is Comp_W, the distance information of a peripheral pixel having the label K_D_Comp is set as (distance information of the target pixel+1). Further, in the case in which the label of the peripheral pixel is also the Comp_W, when the distance information of the target pixel is small, the distance information of the peripheral pixel is set as (distance information of the target pixel+1). Further, in the case in which the label of the peripheral pixel is not the Comp_W, the distance information of the peripheral pixel is not updated.

If the transfer of information is performed and the label data of the label plane is updated, the process for the next peripheral pixel goes to S313 in the case of “No” in Step S316. Meanwhile, in Step S314, when the label of the peripheral pixel does not exist in No. 13 and 14 to 28 (No in Step S314), the process for the next peripheral pixel goes to S316.

After the same process is repeated from Step S313, when the process for all peripheral pixels (eight in the above description) is ended (Yes in Step S316), the process for the target pixel is ended. Then, the process for the next pixel is performed in the forward direction (No in Step S317, S311).

In this manner, if the process for all pixels in the forward direction is ended (Yes in Step S317), the above-described backward process is performed similarly to the forward process (Step S318).

In this way, the third labeling according to the first method is performed.

Hereinafter, the second method will be described. According to the second method, when a target pixel has labels C, M and Y, color information thereof is transferred to the peripheral pixels of a candidate to be corrected, so that the labels of the peripheral pixels are updated. Further, the transfer of the information is limited to the range of a predetermined distance (e.g., five pixels) from the pixel having the label “C”, “M” or “Y”. In the second method, a section in the region of the “Monochromatic K Dark”, which exists in a predetermined range from the region of the “Color”, is set as an object to be corrected.

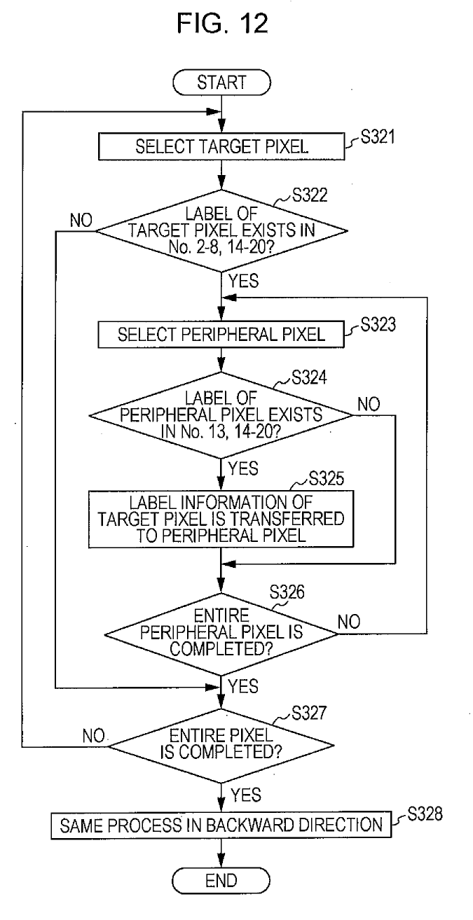

FIG. 12 is a flowchart illustrating the procedure of the third labeling process according to the second method. First, the left upper pixel of a target image is selected as a target pixel (Step S321), and it is checked whether the label of the target pixel at that time exists in No. 2 to 8 and 14 to 20 as illustrated in FIG. 2 with reference to the label plane (Step S322). That is, it is checked whether the label of the target pixel corresponds to C, M or Y as color information. As a result of the checking, when the label of the target pixel does not exist in No. 2 to 8 and 14 to 20 (No in Step S322), the process for the target pixel is ended. Then, the process for the next pixel in the forward direction goes to S321 in the case of “No” in Step S327.

Meanwhile, when the label of the target pixel exists in No. 2 to 8 and 14 to 20 (Yes in Step S322), one peripheral pixel is selected (Step S323), and it is checked whether the label of the peripheral pixel at that time exists in No. 13 and 14 to 20 as illustrated in FIG. 2 with reference to the label plane (Step S324). That is, it is checked whether the peripheral pixel is a candidate to be corrected. As a result of the checking, when the label of the peripheral pixel exists in No. 13 and 14 to 20 (Yes in Step S324), the label information of the target pixel is transferred to the peripheral pixel (Step S325).

The transfer of the color information is performed similarly to the first method. Since the color information is transferred only to pixels existing in the range of five pixels from the pixel having the label of the “Color” as described above, distance information from the pixel having the label of the “Color” is also transferred such that the range (distance) can be understood. The transfer of the distance information is also performed similarly to the first method.

If the transfer of information is performed and the label data of the label plane is updated, the process for the next peripheral pixel goes to S323 in the case of “No” in Step S326. Meanwhile, in Step S324, when the label of the peripheral pixel does not exist in No. 13 and 14 to 20 (No in Step S324), the process for the next peripheral pixel goes to S326.

After the same process is repeated from Step S323, when the process for all peripheral pixels (eight in the above description) is ended (Yes in Step S326), the process for the target pixel is ended. Then, the process for the next pixel in the forward direction goes to S321 in the case of “No” in Step S327.

In this manner, if the process for all pixels in the forward direction is ended (Yes in Step S327), the above-described backward process is performed similarly to the forward process (Step S328).

In this way, the third labeling according to the second method is performed.

Hereinafter, the third method will be described. According to the third method, when a target pixel is a candidate to be corrected, color information of peripheral pixels having the labels W, C, M and Y is transferred to the target pixel, so that the label of the target pixel is updated. Further, the transfer of the information of W is limited to the range of a predetermined distance (e.g., five pixels) from the pixel having the label “W”, similarly to the first method.

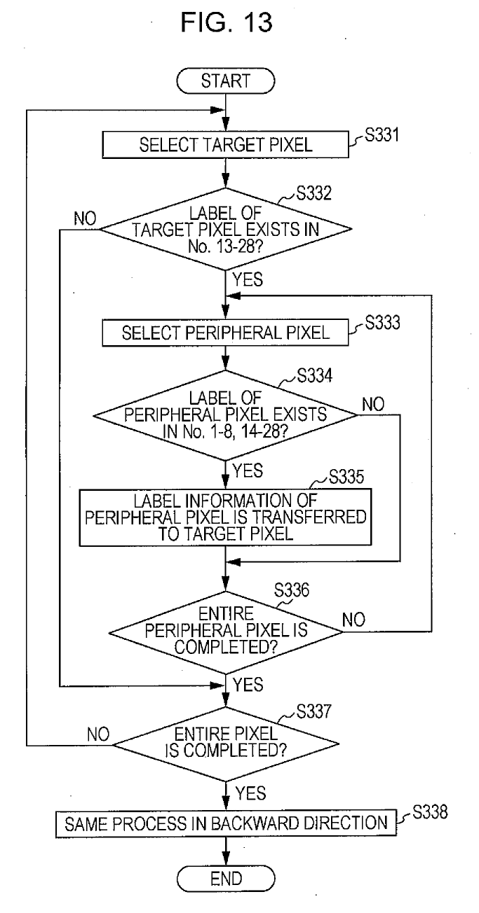

FIG. 13 is a flowchart illustrating the procedure of the third labeling process according to the third method. First, the left upper pixel of a target image is selected as a target pixel (Step S331), and it is checked whether the label of the target pixel at that time exists in No. 13 to 28 as illustrated in FIG. 2 with reference to the label plane (Step S332). That is, it is checked whether the target pixel is a candidate to be corrected. As a result of the checking, when the label of the target pixel does not exist in No. 13 to 28 (No in Step S332), the process for the target pixel is ended. Then, the process for the next pixel in the forward direction goes to S331 in the case of “No” in Step S337.

Meanwhile, when the label of the target pixel exists in No. 13 to 28 (Yes in Step S332), one peripheral pixel is selected (Step S333), and it is checked whether the label of the peripheral pixel at that time exists in No. 1 to 8 and 14 to 28 as illustrated in FIG. 2 with reference to the label plane (Step S334). That is, it is checked whether the label of the peripheral pixel corresponds to W, C, M or Y as color information. As a result of the checking, when the label of the peripheral pixel exists in No. 1 to 8 and 14 to 28 (Yes in Step S334), the label information of the peripheral pixel is transferred to the target pixel (Step S335).

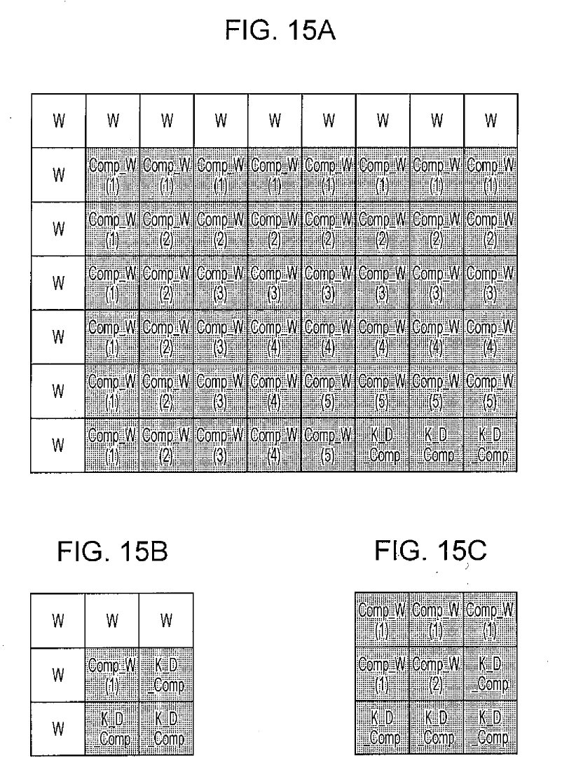

The transfer of the color information is performed similarly to the first method. Further, when the transferred color is W, the color information is transferred only to pixels existing in the range of five pixels from the pixel having the label “W” as described above. Herein, in order to allow the range (distance) to be understood, distance information from the pixel having the label “W” is also transferred thereto. FIGS. 15A to 15C are views illustrating the transfer of information related to the W.

FIGS. 15A to 15C illustrate an example in which the region (gray section) of the “Monochromatic K Dark” is in contact with the region (white section) of the “White”. As illustrated in FIG. 15A, pixels (having small rectangular shapes) existing in the region of the “White” has the label W. Further, among pixels (having small rectangular shapes) existing in the region of the “Monochromatic K Dark”, pixels existing within the range of five pixels from the region of the “White” have the label Comp_W together with information on the shortest distance from the region of the “White”. Since the information of the W is not transferred to pixels which do not exist in the range of the five pixels from the region of the “White”, the pixels have the label K_D_Comp.

FIG. 15B illustrates the nine left upper pixels in FIG. 15A. Herein, when a target pixel is the center pixel, since there exists a peripheral pixel having the label W, the label of the target pixel is updated to Comp_W (1). In this way, when there exists the peripheral pixel having the label “W”, the distance information of the target pixel is set as (1).

FIG. 15C illustrates the nine left upper pixels in FIG. 15A. Herein, when a target pixel is the center pixel, since there exists a peripheral pixel having the label Comp_W (1), the label of the target pixel is updated to Comp_W (2). In this way, when there exists the peripheral pixel having the label “Comp_W”, the distance information of the target pixel is set as (minimum value of the distance information of the peripheral pixel+1).

If the transfer of information is performed and the label data of the label plane is updated as described above, the process for the next peripheral pixel goes to S333 in the case of “No” in Step S336. Meanwhile, in Step S334, when the label of the peripheral pixel does not exist in No. 1 to 8 and 14 to 28 (No in Step S334), the process for the next peripheral pixel goes to S336.

After the same process is repeated from Step S333, when the process for all peripheral pixels (eight in the above description) is ended (Yes in Step S336), the process for the target pixel is ended. Then, the process for the next pixel in the forward direction goes to S331 in the case of “No” in Step S337.

In this manner, if the process for all pixels in the forward direction is ended (Yes in Step S337), the above-described backward process is performed similarly to the forward process (Step S338).

In this way, the third labeling according to the third method is performed.

Hereinafter, the fourth method will be described. According to the fourth method, when a target pixel is a candidate to be corrected, color information of peripheral pixels having the labels C, M and Y is transferred to the target pixel, so that the label of the target pixel is updated. Further, the transfer of the information is limited to the range of a predetermined distance (e.g., five pixels) from the pixel having the label “C”, “M” or “Y”. In the fourth method, a section in the region of the “Monochromatic K Dark”, which exists in a predetermined range from the region of the “Color”, is set as an object to be corrected.

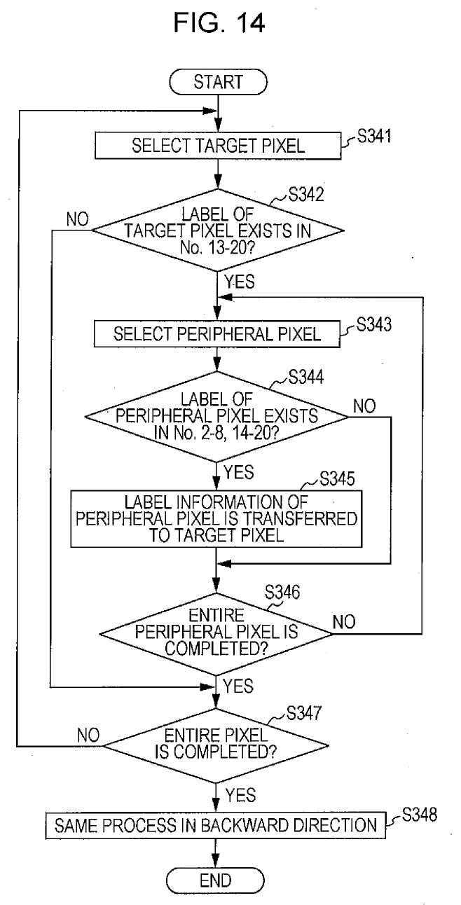

FIG. 14 is a flowchart illustrating the procedure of the third labeling process according to the fourth method. First, the left upper pixel of a target image is selected as a target pixel (Step S341), and it is checked whether the label of the target pixel at that time exists in No. 13 to 20 as illustrated in FIG. 2 with reference to the label plane (Step S342). That is, it is checked whether the target pixel is a candidate to be corrected. As a result of the checking, when the label of the target pixel does not exist in No. 13 to 20 (No in Step S342), the process for the target pixel is ended. Then, the process for the next pixel in the forward direction goes to S341 in the case of “No” in Step S347.

Meanwhile, when the label of the target pixel exists in No. 13 to 20 (Yes in Step S342), one peripheral pixel is selected (Step S343), and it is checked whether the label of the peripheral pixel at that time exists in No. 2 to 8 and 14 to 20 as illustrated in FIG. 2 with reference to the label plane (Step S344). That is, it is checked whether the label of the peripheral pixel corresponds to C, M or Y as color information. As a result of the checking, when the label of the peripheral pixel exists in No. 2 to 8 and 14 to 20 (Yes in Step S344), the label information of the peripheral pixel is transferred to the target pixel (Step S345).

The transfer of the color information is performed similarly to the first method. Further, when the transferred color is W, the color information is transferred only to pixels existing in the range of five pixels from the pixel having the label of the “Color” as described above, distance information from the pixel having the label of the “Color” is also transferred such that the range (distance) can be understood. The transfer of the distance information is also performed similarly to the third method.

If the transfer of information is performed and the label data of the label plane is updated as described above, the process for the next peripheral pixel goes to S343 in the case of “No” in Step S346. Meanwhile, in Step S344, when the label of the peripheral pixel does not exist in No. 2 to 8 and 14 to 20 (No in Step S344), the process for the next peripheral pixel goes to S346.

After the same process is repeated from Step S343, when the process for all peripheral pixels (eight in the above description) is ended (Yes in Step S346), the process for the target pixel is ended. Then, the process for the next pixel in the forward direction goes to S341 in the case of “No” in Step S347.

In this manner, if the process for all pixels in the forward direction is ended (Yes in Step S347), the above-described backward process is performed similarly to the forward process (Step S348).

In this way, the third labeling according to the fourth method is performed.

If the third labeling process is ended as described above, since the object to be corrected is finally detected, the procedure goes to Step S4 of FIG. 3 so that the correction process is performed.

The correction process is performed based on the label information maintained in the label plane as a result of the third labeling. In detail, the bitmap data of the CMYK is changed with respect to the pixels to which the labels No. 14 to 20 as illustrated in FIG. 2 are assigned, so that the correction as the measure against the misregistration is performed. In more detail, the process varies depending on a first case in which the value (black gradation value) of the K plane of a pixel to be corrected is the highest value of 255, and a second case in which the value is not the highest value. In the first case, predetermined gradation value (e.g., 51) is added to the bitmap data with respect to the color of color information of the label assigned to the pixel. In the second case, the bitmap data is changed such that the color of the monochromatic K of the pixel is represented by a mixed color including colors other than a black color.

For example, when the label of a pixel to be corrected is the Comp_CM and the gradation value of K thereof is 255, 51 is respectively added to the gradation values of the C and the M, so that the bitmap data of the pixel is corrected from (0, 0, 0, 255) to (51, 51, 0, 255) in the sequence of the CMYK. Further, when the gradation value of the K of the pixel to be corrected is not 255, a conversion table from a black monochromatic color to the so-called composite K of a case where the black monochromatic color is represented by a mixed color, that is, a case where the black monochromatic color is represented by the composite K, is prepared in advance in the ROM 26 or the like, so that the bitmap data is converted using the conversion table, thereby performing the correction. For example, the bitmap data is corrected from (0, 0, 0, 235) to (102, 92, 83, 192) in the sequence of the CMYK.

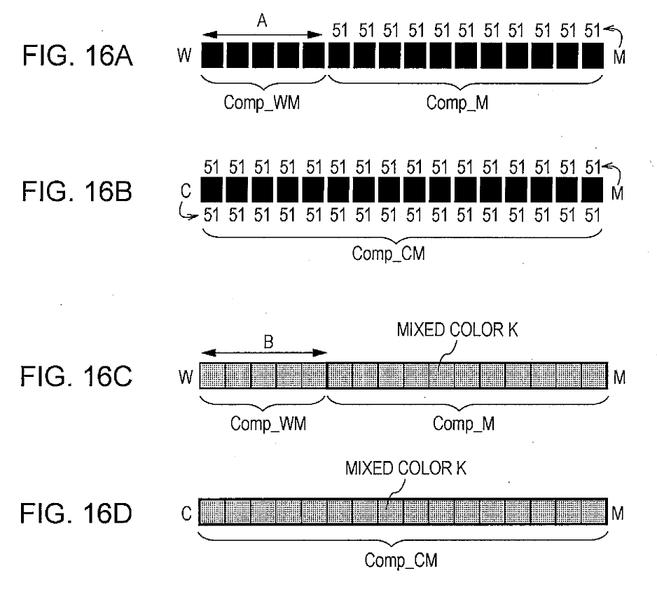

FIGS. 16A to 16D are views illustrating the content of the correction process. FIGS. 16A to 16D are exemplary views illustrating a case in which the above-described third labeling is performed using the first method and the third method. FIG. 16A illustrates a case in which 16 pixels represented by a monochromatic K and having a gradation value (255, black) of the K are arranged in a row while being in contact with pixels having the label “W” at the left end thereof and pixels having the label “M” at the right end thereof. In such a case, through the above-described third labeling process, the right 11 pixels have the label Comp_M and the left five pixels indicated by A in FIG. 16A have the label Comp_WM. Further, based on the above-described correction process, the gradation value of the M is increased by 51 with respect to the pixels having the label Comp_M, and the pixels having the label Comp_WM are not corrected.

FIG. 16B illustrates a case in which 16 pixels represented by a monochromatic K and having a gradation value (255, black) of the K are arranged in a row while being in contact with pixels having the label “C” at the left end thereof and pixels having the label “M” at the right end thereof, similarly to the case of FIG. 16A. In such a case, all pixels have the label Comp_CM through the above-described third labeling process, and the gradation values of the C and the M are increased by 51 based on the above-described correction process.

FIG. 16C illustrates a case in which 16 pixels represented by a monochromatic K and having a gradation value (other than 255, gray color) of the K are arranged in a row while being in contact with pixels having the label “W” at the left end thereof and pixels having the label “M” at the right end thereof. In such a case, through the above-described third labeling process, the right 11 pixels have the label Comp_M and the left five pixels indicated by B in FIG. 16C have the label Comp_WM. Further, based on the above-described correction process, representation of the composite K is applied to the pixels having the label Comp_M, and the pixels having the label Comp_WM are not corrected.

FIG. 16D illustrates a case in which 16 pixels represented by a monochromatic K and having a gradation value (other than 255, gray color) of the K are arranged in a row while being in contact with pixels having the label “C” at the left end thereof and pixels having the label “M” at the right end thereof, similarly to the case of FIG. 16C. In such a case, all pixels have the label Comp_CM through the above-described third labeling process, and representation of the composite K is applied to all pixels based on the above-described correction process.

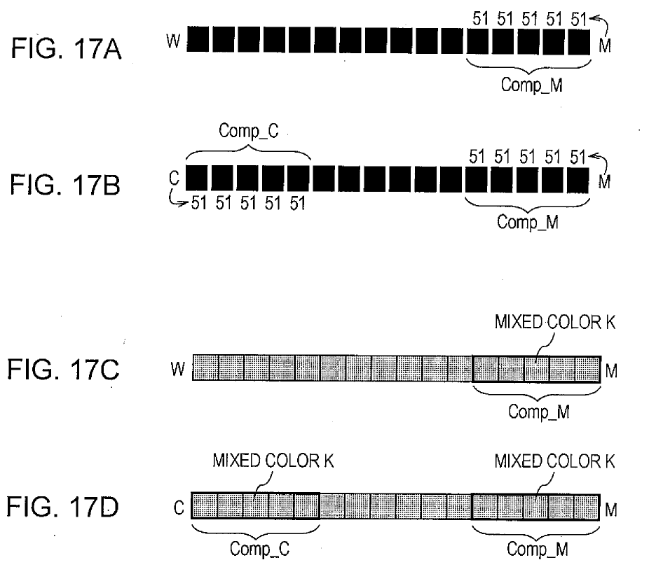

FIGS. 17A to 17D are views illustrating the content of the correction process. FIGS. 17A to 17D are exemplary views illustrating a case in which the above-described third labeling is performed using the second method and the fourth method.

FIG. 17A illustrates the state of pixels identical to the case of FIG. 16A, except that only the right five pixels are corrected so that they have the label Comp_M through the above-described third labeling process, and the gradation value of the M is increased by 51 with respect to the pixels having the label Comp_M based on the above-described correction process.

FIG. 17B illustrates the state of pixels identical to the case of FIG. 16B, except that only the left five pixels and only the right five pixels are corrected so that the left five pixels have the label Comp_C and the right five pixels have the label Comp_M through the above-described third labeling process, and the gradation value of the M is increased by 51 with respect to the pixels having the label Comp_M and the gradation value of the C is increased by 51 with respect to the pixels having the label Comp_C based on the above-described correction process.

FIG. 17C illustrates the state of pixels identical to the case of FIG. 16C, except that only the right five pixels are corrected so that they have the label Comp_M through the above-described third labeling process, and representation of the composite K is applied to the pixels based on the above-described correction process.

FIG. 17D illustrates the state of pixels identical to the case of FIG. 16D, except that only the left five pixels and only the right five pixels are corrected so that the left five pixels have the label Comp_C and the right five pixels have the label Comp_M through the above-described third labeling process, and representation of the composite K is applied to the left five pixels and the right five pixels based on the above-described correction process.

Further, according to the correction as described above, when an object to be corrected is a black color (gradation value thereof is 255), gradation values of each color are uniformly increased (herein, 51). However, the increase amount may vary depending on the position of a pixel to be corrected. For example, the increase amount can be set as 51 at maximum with respect to a pixel being in contact with a pixel having the label “Color”, and the increase amount can be reduced with the increase in distance from the pixel having the label “Color”.

In this way, the correction process is performed, so that the correction as the measure against the misregistration by the printer 2 is completed.

Through the process, the region of the “Monochromatic K Dark” being in contact with the region of the “Color” is corrected, so that the printing process is performed using the corrected bitmap data as described above, thereby effectively preventing a void from occurring in the vicinity of characters or the like.

According to the above description, the generation process of the label data is performed through three separated stages from the first labeling to the third labeling. However, after the first to third labeling are incorporated, a one-time reciprocation process in the forward direction and backward direction for each pixel as described above can be applied.

As described above, in the printer 2 according to the embodiment, since an object to be corrected is determined in pixel units, each pixel is allowed to have label information, and the information is transferred to peripheral pixels so that an object to be corrected and the content of correction are decided, the correction process as the measure against the misregistration can be reliably and efficiently performed. Further, since the transferred label information includes color information of a region being in contact with a region to be corrected, suitable and useful correction can be performed. In addition, since the transferred label information includes distance information from the region being in contact with the region to be corrected, a correction range can be specified only in a more suitable region and efficient correction is possible.

Further, when a dark gray pixel having only the color of K and a gradation value equal to or larger than a predetermined value is selected as a candidate to be corrected, and a pixel having only the color of K and a gradation value slightly different from that of the relevant pixel exists in the vicinity of the relevant pixel or in a region where pixels having a gradation value identical to that of the relevant pixel are arranged in a row from the relevant pixel, since the relevant pixel is excluded from an object to be corrected, a region including gradation is not corrected. Thus, a new color is added to the region including gradation through correction, so that the original image quality can be prevented from being degraded.

Further, the above-described distance information from the white region is transferred, and a region having a predetermined width while being adjacent to a region of “Color” other than white is selected as an object to be corrected, so that correction can be prevented from being performed with respect to a section being in contact with the white region. Thus, when a misregistration occurs, a color, which does not originally exists, can be prevented from occurring in the section being in contact with the white region.

Furthermore, when correction is performed, in the case in which a gradation value of a region to be corrected is not 255 (jet black), correction is performed such that the original color of the monochromatic K is represented by the composite K, so that the color tone can be prevented from being changed by correction.

According to the embodiment as described above, the print data generated in the PDL format by the host computer 1 is transmitted to the printer 2, and the generation and correction of the bitmap data are performed in the printer 2. However, the generation and correction of the bitmap data may be performed in the host computer 1. In such a case, the printer driver 11 performs the correction process as the measure against the misregistration in the same manner as that described above, and transmits print data including the corrected bitmap data to the printer 2.

The protection range of the invention is not limited to the above-described embodiment and covers the inventions set forth in the appended claims and equivalents thereof.

The entire disclosure of Japanese Patent Application No. 2009-005896, filed Jan. 14, 2009 is expressly incorporated by reference herein.

What is claimed is:

1. An image forming apparatus for performing image formation by using various colorants, the image processing apparatus comprising:
a bitmap data generation unit that generates bitmap data, in which each pixel has a gradation value of each color of the colorants, with respect to image formation objects;
a label generation unit that generates label information of a relevant pixel for each pixel based on the bitmap data or label information of peripheral pixels of the relevant pixel; and
a correction unit that corrects the bitmap data based on the label information,
wherein the image formation is performed based on the corrected bitmap data, and
the label information includes information on a color of a pixel adjacent to a region to be corrected when the pixel exists in the region to be corrected, and includes information for identifying a color of the relevant pixel when the pixel does not exist in the region to be corrected.

2. The image forming apparatus according to claim 1, wherein the label information of the pixel existing in the region to be corrected includes distance information from the adjacent pixel.

3. The image forming apparatus according to claim 1, wherein the region to be corrected is a region where the gradation value of a black color of the bitmap data is equal to or larger than a predetermined value while the gradation value of other colors is 0, and does not include a section in which the gradation value of the black color varies.

4. The image forming apparatus according to claim 1, wherein, among the image formation objects, in a region which is in contact with a pixel in which the gradation value of all colors of the bitmap data is 0, and in which the gradation value of a black color of the bitmap data is equal to or larger than a predetermined value while the gradation value of other colors is 0, label information of a pixel in a predetermined range from the pixel being in contact with the region includes distance information from the pixel being in contact with the region.

5. The image forming apparatus according to claim 1, wherein, when the gradation value of the bitmap data of the region to be corrected is a highest value for a black color and is 0 for remaining colors, the correction unit performs the correction by increasing a gradation value of a relevant bitmap data with respect to the color of the adjacent pixel by a predetermined amount, and, when the gradation value of the bitmap data of the region to be corrected is not the highest value in the case of the black color and is 0 in the case of the remaining colors, the correction unit performs the correction by changing the gradation value of the bitmap data into values of each color of a case where a monochromatic black color having the gradation value of the black color is represented by a mixed black color including colors other than the black color.

6. The image forming apparatus according to claim 1, wherein the label generation unit includes:
a first labeling execution section that generates label information of a relevant image formation object, in which one of plural pieces of first classification information has been assigned to each pixel, based on the bitmap data in which each pixel of the image formation object has the gradation value of each color of the colorants;
a second labeling execution section that updates the label information of the relevant pixel into relevant second classification information, which represents whether the relevant pixel is a candidate to be corrected, by assigning the relevant second classification information to a pixel, to which a predetermined one of the first classification information has been assigned by the first labeling execution section, based on the label information of the peripheral pixels of the relevant pixel; and
a third labeling execution section that updates the label information of the relevant pixel into relevant third classification information, which is used for performing the correction, by assigning the relevant third classification information to a pixel, to which the second classification information representing that the relevant pixel is the candidate to be corrected has been assigned by the second labeling execution section, based on the first classification information assigned to the pixel adjacent to the region to be corrected inclusive of the relevant pixel,
wherein the correction unit performs the correction process of the bitmap data with respect to the pixel, to which the third classification information is assigned, based on the third classification information of the label information, and
the image formation is performed based on the corrected bitmap data.

7. The image forming apparatus according to claim 6, wherein the third classification information includes the color information of the pixel adjacent to the region to be corrected, and
the third labeling execution section generates the third classification information from the assigned first or third classification information, and assigns the generated third classification information to peripheral pixels of the pixel to which the third classification information has been assigned.

8. The image forming apparatus according to claim 7, wherein the third classification information further includes distance information from the pixel adjacent to the region to be corrected to the pixel to which the third classification information has been assigned.

9. The image forming apparatus according to claim 6, wherein, when the label information of the peripheral pixels is the second classification information, which represents that the relevant pixel is not the candidate to be corrected, the second labeling execution section assigns the second classification information, which represents that the relevant pixel is not the candidate to be corrected, to the pixel.

10. The image forming apparatus according to claim 6, wherein the predetermined one of the first classification information of a pixel, for which the second labeling execution section performs the assignment, is first classification information representing a monochromatic color with the gradation value in a predetermined range, and
when the first classification information assigned to the peripheral pixel is first classification information representing a monochromatic color identical to a corresponding pixel, and a difference between a gradation value of a relevant peripheral pixel and a gradation value of the corresponding pixel is larger than 0 and is smaller than a predetermined value, the second labeling execution section assigns the second classification information, which represents that the relevant pixel is not the candidate to be corrected, to the corresponding pixel.

11. The image forming apparatus according to claim 6, wherein the correction unit does not perform the correction process with respect to a pixel to which a predetermined one of the third classification information has been assigned.

12. The image forming apparatus according to claim 6, wherein, when the pixel to be corrected has a monochromatic black color and the gradation value of the pixel is a highest value, the correction unit increases a gradation value of the bitmap data of the relevant pixel with respect to the color of the pixel, which is adjacent to the region to be corrected, by a predetermined amount, and
when the pixel to be corrected has the monochromatic black color and the gradation value of the pixel is not the highest value, the correction unit changes a gradation value of a relevant bitmap data of the relevant pixel into values of each color of a case where a monochromatic black color having the gradation value of the black color is represented by a mixed black color including colors other than the black color.

13. An image forming method in an image forming apparatus for performing image formation by using various colorants, the image processing method comprising:
generating bitmap data, in which each pixel has a gradation value of each color of the colorants, with respect to image formation objects;
generating label information of a relevant pixel for each pixel based on the bitmap data or label information of peripheral pixels of the relevant pixel; and
correcting the bitmap data based on the label information,
wherein the image formation is performed based on the corrected bitmap data, and
the label information includes information on a color of a pixel adjacent to a region to be corrected when the pixel exists in the region to be corrected, and includes information for identifying a color of the relevant pixel when the pixel does not exist in the region to be corrected.

14. A computer readable recording medium storing a print data generation program that causes a host device of an image forming apparatus to execute a process of generating print data for the image forming apparatus that performs image formation by using various colorants, the print data generation program causing the host device to execute:
generating bitmap data, in which each pixel has a gradation value of each color of the colorants, with respect to image formation objects;
generating label information of a relevant pixel for each pixel based on the bitmap data or label information of peripheral pixels of the relevant pixel; and
correcting the bitmap data based on the label information,
wherein the image formation is performed based on the print data including the corrected bitmap data, and
the label information includes information on a color of a pixel adjacent to a region to be corrected when the pixel exists in the region to be corrected, and includes information for identifying a color of the relevant pixel when the pixel does not exist in the region to be corrected.
